(19) United States
(12) Patent Application Publication
(10) Pub. No.: US 2005/0213650 A1
(43) Pub. Date: Sep. 29, 2005

(54) Minimizing the differential delay in ADSL2 and ADSL2+ to support bonding

(76) Inventor: Cory S. Modlin, Chevy Chase, MD (US)

Correspondence Address: TEXAS INSTRUMENTS INCORPORATED, P O BOX 655474, M/S 3999, DALLAS, TX, 75265, US

(21) Appl. No.: 11/085,992

(22) Filed: Mar. 22, 2005

Related U.S. Application Data
(60) Provisional application No. 60/556,269, filed on Mar. 25, 2004.

(51) Int. Cl. H04B 1/38

(52) U.S. Cl. 375/222

(57) ABSTRACT

A method of constructing a valid set of configuration parameters for ADSL2 and ADSL2+ compliant systems include selecting delays of a power of two ms, in which the ADSL2 or ADSL2+ compliant system may also possess a selected minimum noise protection value to produce maximum downstream and upstream net data rates corresponding to the selected delay and the selected minimum noise protection value.

### CROSS-REFERENCE TO RELATED APPLICATIONS

This application claims the benefit of U.S. Provisional Patent Application No. 60/556,269, filed Mar. 25, 2004.

### FIELD OF THE INVENTION

The present invention is generally related to multiple transceivers forming a bonding group in Asymmetric Digital Subscriber Line, versions 2 and 2+, i.e., ADSL2 and ADSL2+, respectively, where the differential delay among bonded members of the group is controlled through a minimum delay parameter, derived from International Telecommunications Union (ITU) G.994.1. Construction of a valid set of configuration parameters involves the interdependence of the minimum delay, a minimum impulse noise protection, a minimum overhead message rate, a minimum net data rate, and the data rate granularity.

### BACKGROUND OF THE INVENTION

The net data rate, impulse noise protection (INP), interleaver delay, and overhead rates are all interdependent variables in ITU Recommendations G.992.3 and G.992.5 for ADSL2 and ADSL2+, respectively. Limits on the minimum and maximum net data rate, the minimum INP, the maximum delay, and the minimum overhead rate can be set in ADSL2 and ADSL2+, through the Management Information Base (MIB) defined by ITU Recommendation G.997.1. Previous recognition of the relationship among these parameters is evident in other contributions. In ITU document SS-063, it was noted that certain values of data rates and overhead rates can not be supported simultaneously. Similarly, in ITU document MC-082, limits on INP, data rates, and the maximum delay are described.

The interdependence of data rate, INP, delay, and overhead rate can be seen in the expressions for each of these variables. ADSL2 defines the framing parameters: Kₚ, the number of octets in a mux data frame, Mₚ; Reed-Solomon codeword, Tₚ, which is defined by noting that an overhead octet is inserted into every Tₚ^{th} mux data frame; Iₚ, the number of coded bits in a Discrete Multi-Tone (DMT) symbol; and Kₚ, the interleaver depth. ADSL2 also defines derived parameters N_{FEC,p}=Mₚ*Kₚ+Rₚ, i.e., the Reed-Solomon codeword size, and Sₚ=8*N_{FEc,p}/Lₚ, i.e., the number of DMT symbols per Reed-Solomon codeword.

In ADSL2, the net data rate is given by
net data rate=Mₚ*Kₚ/Sₚ*32−overhead rate kbps (1)
where the overhead rate is
ORₚ=Mₚ/(Sₚ*Tₚ)*32 kbps. (2)
The period of the overhead channel is

$${PER}_{p} = {T}_{p} * {S}_{p} * {SEQ}_{p} / ( 4 * {M}_{p} ) = {SEQ}_{p} * 8 / {OR}_{p} . \qquad ( 3 )$$

The impulse noise protection is given by
INP=8*Dₚ*tₚ/LₚDMT symbols, (4)
where tₚ is the correction capability of the Reed-Solomon code, normally equal to Rₚ/2. Finally, the interleaver delay is

$$delay = \frac{ceil ( {S}_{p} * {D}_{p} )}{4} ms \qquad ( 5 )$$

There are additional constraints in ADSL2, such as Mₚ is a power of two between 1 and 16, Mₚ/Sₚ must be less than or equal to two, or alternatively in ADSL2+, three, Dₚ is a power of two between 1 and 64 downstream or 1 and 8 upstream, Sₚ □½(⅓ ADSL2+), the overhead rate must be less than 64 kbps, delay □ 1 ms, where setting the delay equal to 1 ms has a special interpretation in recommendation G.997.1 meaning that Sₚ □1 and Dₚ=1, and the period of the overhead channel must be between 15 ms and 20 ms.

In some cases it is somewhat obvious that certain combinations of parameter settings are invalid while in other cases it is not obvious. For example, it is clear that you can not specify a maximum delay of 1 ms and expect to achieve an impulse noise protection of 16 DMT symbols. But it is not as obvious that you can set the limits on the interleaver delay to between 13 and 15 ms and be unable to achieve an overhead rate of greater than 39 kbps, as described in ITU document MC-063.

When bonding, the differential delay among bonded transceivers translates directly into implementation complexity. With differential delay, the receiver needs to buffer possibly multiple packets over a low delay link while waiting for a packet over a high delay link to arrive. The amount of buffering is directly proportional to the difference in delay, times the data rate. For example, even a 1 ms delay difference at a data rate of 10 Mbps results in a need to buffer approximately 1250 bytes. Therefore, it is desirable to keep the differential delay as small as possible.

One relatively simple way to achieve the minimum possible differential delay and to guarantee that any overhead rate can be met is to set the delay_max=delay_min=1, 2, 4, 8, 16, or 32 ms. Because the interleaver depth is always a power of two, from the expression for interleaver delay, that is, equation (5) above, we see that limiting Sp to a power of two will satisfy the delay restriction. In this case, in equation (2), we see that this permits an overhead rate of up to exactly 64 kbps, the maximum allowed. This restriction is similar to ADSL1 framing and allows net data rates up to about 16 Mbps.

For an overhead rate of 64 kbps, the maximum message overhead rate is 60.8 kbps in the worst case. To this, from equation (3), we calculate SEQₚ assuming the period is at its smallest allowed value of 15 ms. In this case, SEQₚ=120. In the case where the Cyclic Redundancy Check (CRC), indicator bits, and overhead messages are all carried in the same latency path, that is, where p is the lowest latency path, six of the 120 bytes are reserved for the CRC, etc. and are not used for the overhead messages. Therefore, the overhead message rate is 114/120*64=60.8 kbps. Similar calculations can be done for other overhead rates.

In ADSL2+, if the maximum rate for any of the bonded pairs is over 16 Mbps, we can use the same technique and set delay_min=delay_max=1.33, 2.67, or 5.33 ms, which limits Sp to 2ⁿ/3 for n=0, 1, 2, 3, . . . 7. We mention that values of Sp higher than ⅓ are allowed since not all bonded pairs need to have Sₚ=⅓. However, note that setting the delay to 10.667 ms is not allowed when Sₚ=⅓, since this would require Dₚ>64. If you want to set the delay higher than 5.33 ms, you can select a delay that is a power of two. Setting the delay to and of these three values means that the overhead rate can not exceed 48 kbps, as in equation (2) with Mₚ=1, Tₚ−2 and Sₚ=⅓. Hence, from equation (3), SEQₚ=90, when PERₚ=15 ms, yielding a worst case message overhead rate of 84/90*48=44.8 kbps.

Setting delay_max=delay_min and restricting it to a power of two, also restricts the data rate granularity. As we see from the formula for the net data rate, the data rate granularity is a multiple of 64 kbps, 32 kbps, 16 kbps, or 8 kbps for Mₚ/Sₚ=2, 1, ½, and ¼, respectively. The selection of Mₚ/Sₚ is made based on the requirements of the overhead channel rate. If an overhead channel rate of 32 kbps is required, for example, Mₚ/Sₚ can not be less than 1 and the data rate granularity is 32 kbps.

There remains a need to define the minimum delay to facilitate bonding in ADSL2 and ADSL2+, since differential delay among bonded transceivers means that more memory for buffering is required at the receiver. However, constraints need to be placed on the maximum and minimum delays in order to meet other constraints in ADSL2 and ADSL2+, such as the overhead rate, the minimum and maximum data rates, and the impulse noise protection (INP).

### SUMMARY OF THE INVENTION

An aspect of the an exemplary embodiment of the present invention provides a method of constructing a valid set of configuration parameters for an Asymmetric Digital Subscriber Line, version 2 (ADSL2) compliant system. The method includes selecting a delay of one of 1, 2, 4, 8, 16, and 32 ms, in which selecting delay=1 ms in the ADSL2 compliant system having a selected minimum noise protection (INP_min)=0 Discrete Multi-tone (DMT) symbols produces a maximum downstream net data rate of 14656 kbps, in which selecting delay=2 ms in the ADSL2 compliant system having selected one of INP_min=0 V₂, 1 and 2 DMT symbols produces maximum downstream net data rates of 14656, 7104, 3008, and 960, respectively, in which a delay=4 ms in the ADSL2 compliant system having one of INP_min=0, ½, 1, 2, and 4 DMT symbols provides maximum downstream net data rates of 14656, 13632, 7104, 3008, and 960 kbps, respectively, in which a delay=8 ms in the ADSL2 compliant system having one of INP_Min=0, ½, 1, 2, 4 and 8 DMT symbols provides maximum downstream net data rates of 14656, 13632, 13632, 7104, 3008, and 960 kbps, respectively, in which a delay=16 ms in the ADSL2 compliant system having one of INP_min=0, ½, 1, 2, 4, 8 and 16 DMT symbols provides maximum downstream net data rates of 8064, 7552, 7552, 7552, 3502, 1472, and 448 kbps, respectively, and in which a delay=32 ms in the ADSL2 compliant system having one of INP_min=0, ½, 1, 2, 4, 8 and 16 DMT symbols provides maximum downstream net data rates of 3968, 3712, 3712, 3712, 3712, 1728, and 704 kbps, respectively, and selecting a minimum net data rate for downstream to be less than a particular maximum downstream net data rate that corresponds to a selected delay and a selected one of INP-min values.

Another aspect of the an exemplary embodiment of the present invention provides a method of constructing a valid set of configuration parameters for an Asymmetric Digital Subscriber Line, version 2 (ADSL2) compliant system. The method includes selecting a delay of one of 1, 2, 4, 8, 16, and 32 ms, in which selecting delay=1 ms in the ADSL2 compliant system having a selected minimum noise protection (INP_min)=0 Discrete Multi-tone (DMT) symbols produces a maximum upstream net data rate of 3520 kbps, in which selecting delay=2 ms in the ADSL2 compliant system having selected one of INP_min=0, ½, 1 and 2 DMT symbols produces maximum upstream net data rates of 3520, 3072, 1472, and 448, respectively, in which a delay=4 ms in the ADSL2 compliant system having one of INP_min=0, ½, 1, 2, and 4 DMT symbols provides maximum upstream net data rates of 3520, 3264, 1728, 704, and 192 kbps, respectively, in which a delay=8 ms in the ADSL2 compliant system having one of NP_mmin=0, ½, 1, 2, 4 and 8 DMT symbols provides maximum upstream net data rates of 1920, 1856, 1792, 832, 320, and 64 kbps, respectively, in which a delay=16 ms in the ADSL2 compliant system having one of INP_min=0, ½, 1, 2, 4, 8 and 16 DMT symbols provides maximum upstream net data rates of 896, 896, 896, 832, 384, and 128 kbps, respectively, and in which a delay=32 ms in the ADSL2 compliant system having one of INPmin=0, ½, 1, 2, 4, 8 and 16 DMT symbols provides maximum upstream net data rates of 416, 416, 416, 416, 384, 160, and 32 kbps, respectively, and selecting a minimum net data rate for downstream to be less than a particular maximum upstream net data rate that corresponds to a selected delay and a selected one of INP-min values.

Yet another aspect of the an exemplary embodiment of the present invention provides a method of constructing a valid set of configuration parameters for an Asymmetric Digital Subscriber Line, version 2+ (ADSL2+) compliant system. The method includes selecting a delay of one of 1, 2, 4, 8, 16, and 32 ms, in which selecting delay=1 ms in the ADSL2+compliant system having a selected minimum noise protection (INP_min)=0 Discrete Multi-tone (DMT) symbols produces a maximum downstream net data rate of 24416 kbps, in which selecting delay=2 ms in the ADSL2+ compliant system having selected one of INP_min=0, ½, 1 and 2 DMT symbols produces maximum downstream net data rates of 16256, 7104, 3008, and 960, respectively, in which a delay=4 ms in the ADSL2+compliant system having one of INP_min=0, ½, 1, 2, 4, and 8 DMT symbols provides maximum downstream net data rates of 16256, 15232, 7104, 3008, 960, and 416 kbps, respectively, in which a delay=8 ms in the ADSL2 compliant system having one of INP_min=0, ½, 1, 2, 4 and 8 DMT symbols provides maximum downstream net data rates of 16256, 15744, 15232, 7104, 3008, and 960 kbps, respectively, in which a delay=16 ms in the ADSL2 compliant system having one of INP_min=0, ½, 1, 2, 4, 8 and 16 DMT symbols provides maximum downstream net data rates of 8064, 7936, 7808, 7552, 3520, 1472, and 448 kbps, respectively, and in which a delay=32 ms in the ADSL2 compliant system having one of INP_min=0, ½, 1, 2, 4, 8 and 16 DMT symbols provides maximum downstream net data rates of 3968, 3968, 3904, 3840, 3712, 1728, and 704 kbps, respectively, and selecting a minimum net data rate for downstream to be less than a particular maximum downstream net data rate that corresponds to a selected delay and a selected one of INP-min values.

Yet another aspect of the an exemplary embodiment of the present invention provides a method of constructing a valid set of configuration parameters for an Asymmetric Digital Subscriber Line, version 2+ (ADSL2+) compliant system. The method includes selecting a delay of one of 1.33, 2.67, and 5.33 ms, in which selecting delay=1.33 ms in the ADSL2+compliant system having selected minimum noise protection (INP_min)=0, ½, 1, and 2 Discrete Multi-tone (DMT) symbols produces maximum downstream net data rates of 24416, 6560, 2432, and 416 kbps, respectively, in which selecting delay=2,67 ms in the ADSL2+compliant system having selected one of INP_min=0, ½, 1, 2 and 4 DMT symbols produces maximum downstream net data rates of 24416, 1470, 6560, 2432, and 416, respectively, in which a delay=5.33 ms in the ADSL2+compliant system having one of INP_min=0, ½, 1, 2, 4, and 8 DMT symbols provides maximum downstream net data rates of 24416, 23264, 14720, 6560, 2432, and 416 kbps, respectively, and selecting a minimum net data rate for downstream to be less than a particular maximum downstream net data rate that corresponds to a selected delay and a selected one of INP-min values.

Yet another aspect of the an exemplary embodiment of the present invention provides a method of constructing a valid set of configuration parameters for an Asymmetric Digital Subscriber Line, version 2+ (ADSL2+) compliant system. The method includes selecting a delay of one of 1, 2, 4, 8, 16, and 32 ms, in which selecting delay=1 ms in the ADSL2+compliant system having a selected minimum noise protection (INP_min)=0 Discrete Multi-tone (DMT) symbols produces a maximum upstream net data rate of 3520 kbps, in which selecting delay=2 ms in the ADSL2+compliant system having selected one of INP_min=0, ½, 1 and 2 DMT sybols produces maximum upstream net data rates of 3520, 3072, 1472, and 448, respectively, in which a delay=4 ms in the ADSL2+compliant system having one of INP_min=0, ½, 1, 2, and 4 DMT symbols provides maximum upstream net data rates of 3520, 3264, 1728, 704, and 192 kbps, respectively, in which a delay=8 ms in the ADSL2+compliant system having one of INP_min=0, ½, 1, 2, 4 and 8 DMT symbols provides maximum upstream net data rates of 1920, 1865, 1792, 832, 320, and 64 kbps, respectively, in which a delay=16 ms in the ADSL2 compliant system having one of INP_min=0, ½, 1, 2, 4, 8 and 16 DMT symbols provides maximum upstream net data rates of 896, 896, 896, 832, 384, and 128 kbps, respectively, and in which a delay=32 ms in the ADSL2 compliant system having one of INP_min=0, ½, 1, 2, 4, 8 and 16 DMT symbols provides maximum upstream net data rates of 416, 416, 416, 416, 384, 160, and 32 kbps, respectively, and selecting a minimum net data rate for downstream to be less than a particular maximum upstream net data rate that corresponds to a selected delay and a selected one of INP-min values.

### DETAILED DESCRIPTION OF EXEMPLARY EMBODIMENTS OF THE INVENTION

Generally, an exemplary embodiment of the present invention using ADSL2 provides experimental results on how to constrain the maximum delay, i.e., delay_max, the minimum delay, i.e., delay_min, the minimum impulse noise protection, i.e., ¹NP_min, the minimum overhead overhead message rate, i.e., MSGmin, the minimum net data rate, i.e., net_min, and the maximum data rate, i.e., net_max, to allow a valid configuration and successful transceiver training. Various exemplary embodiments of the present invention consider the case when multiple transceivers form a bonding group, where it may be important that differential delay among the bonded transceivers be minimized.

Failure to follow the experimental results of various exemplary embodiments of the present invention may lead to configuration errors, if not supported by the ADSL Transmission Unit-Central Office (ATU-C), and/or initialization failures with a so-called “configuration error” failure cause, if not supported by the ADSL Transmission Unit-Remote (ATU-R).

In various exemplary embodiments of the present invention, we may assume that the differential delay is set to zero and therefore, delay_max=delay_min. This assumption may ensure the minimum possible memory requirements, when bonding.

The experimental results for exemplary embodiments of the present invention using ADSL2 may be as follows:
Set delay_min=delay_max. In either the upstream or downstream direction, all transceivers in a bonding group may use the same delay. The value for delay_min=delay_max may be selected from Tables VI.1 or VI.3, below.
Set the minimum net data rate below the values shown in Tables VI.1 and VI.3 for downstream and upstream, respectively. Depending on the downstream PSD mask and value of BIMAX, the actual maximum net data rate may be lower than those shown in these tables.

The valid range of MSGmin and the corresponding data rate granularity, i.e., (minimum value of net_max-net_min), may be listed in Table VI.4, below.

TABLE VI.1
Maximum downstream net data rate (kbps) for various values
of delay_min = delay_max and INP_min.

| | | INP_min | | | | | | |
|---|---|---|---|---|---|---|---|---|
| | | 0 | ½ | 1 | 2 | 4 | 8 | 16 |
| delay_min | 1^{†} | 14656 | 0 | 0 | 0 | 0 | 0 | 0 |
| delay_max | 2 | 14656 | 7104 | 3008 | 960 | 0 | 0 | 0 |
| (ms) | 4 | 14656 | 13632 | 7104 | 3008 | 960 | 0 | 0 |
| | 8 | 14656 | 14144 | 13663 | 7104 | 3008 | 960 | 0 |
| | 16 | 8064 | 7936 | 7808 | 7552 | 3520 | 1472 | 448 |
| | 32 | 3968 | 3968 | 3904 | 3840 | 3712 | 1728 | 704 |

^{†}In G.997.1 of the recommendation, a 1 ms delay is reserved to mean that S_{P} □ 1 and D_{P}= 1.

TABLE VI.3
Maximum upstream net data rate (kbps) for various values
of delay_min = delay_max and INP_min.

| | | INP_min | | | | | | |
|---|---|---|---|---|---|---|---|---|
| | | 0 | ½ | 1 | 2 | 4 | 8 | 16 |
| delay_min | 1^{†} | 3520 | 0 | 0 | 0 | 0 | 0 | 0 |
| delay_max | 2 | 3520 | 3072 | 1472 | 448 | 0 | 0 | 0 |
| (ms) | 4 | 3520 | 3264 | 1728 | 704 | 192 | 0 | 0 |
| | 8 | 1920 | 1856 | 1792 | 832 | 320 | 64 | 0 |
| | 16 | 896 | 896 | 896 | 832 | 384 | 128 | 0 |
| | 32 | 416 | 416 | 416 | 416 | 384 | 160 | 32 |

^{†}In G.997.1, a 1 ms delay is reserved to mean that S_{P} □ 1 and D_{P} = 1.

TABLE VI.4
Range of MSGmin and minimum data rate granularity
(net_max = net_min) when delay is
selected from Tables VI.1 or VI.3.

| MSGmin (kbps) | data rate granularity (kbps) |
|---|---|
| 61-64 | not supported |
| 29-60 | 64 |
| 14-28 | 32 |
| 6-13 | 16 |
| 4-5 | 8 |

Generally, an exemplary embodiment of the present invention using ADSL2+provides experimental results on how to constrain the maximum delay, i.e., delay_max, the minimum delay, i.e., delay_min, the minimum impulse noise protection, i.e., INP_min, the minimum overhead overhead message rate, i.e., MSGmin, the minimum net data rate, i.e., net_min, and the maximum data rate, i.e., net_max, to allow a valid configuration and successful transceiver training. Various exemplary embodiments of the present invention consider the case when multiple transceivers form a bonding group, where it may be important that differential delay among the bonded transceivers be minimized.

Failure to follow the experimental results of various exemplary embodiments of the present invention may lead to configuration errors, if not supported by the ATU-C, and/or initialization failures with a so-called “configuration error” failure cause, if not supported by the ATU-R.

In various exemplary embodiments of the present invention, we may assume that the differential delay is set to zero and therefore, delay_max=delay_min. This assumption may ensure the minimum possible memory requirements, when bonding.

The experimental results for exemplary embodiments of the present invention using ADSL2+may be as follows:
Set delay_min=delay_max. In either the upstream or downstream direction all transceivers in a bonding group may use the same delay. In the downstream direction, a value for delay can be selected from Table VI.1 (+) or Table VI.2(+), below. When using delays from Table VI.2(+), since the internal representation of delay_min and delay_max are restricted to integers, delay_min may be set to floor(delay_min) and delay_max may be set to ceil(delay_max), where floor(−) and ceil(−) are the ‘greatest integer less than’ and ‘smallest integer greater than’, respectively. In the upstream direction, delay_min and delay_max may be selected from Table VI.3(+), below.
Set the minimum net data rate below the values shown in Table VI.1(+) or VI.2(+) and VI.3(+) for the downstream and upstream, respectively. Depending on the downstream PSD mask and value of BIMAX, the actual maximum net data rate may be lower than those shown in these tables.

Depending on the delay, the valid range of MSGmin and the corresponding data rate granularity (minimum value of net_max-net_min) may be listed in Tables VI.4(+) and VI.5(+).

TABLE VI.1(+)
Maximum downstream net data rate (kbps) for various values
of delay_min = delay_max and INP_min.

| | | INP_min | | | | | | |
|---|---|---|---|---|---|---|---|---|
| | | 0 | ½ | 1 | 2 | 4 | 8 | 16 |
| delay_min | 1^{†} | 24416 | 0 | 0 | 0 | 0 | 0 | 0 |
| delay_max | 2 | 16256 | 7104 | 3008 | 960 | 0 | 0 | 0 |
| (ms) | 4 | 16256 | 15232 | 7104 | 3008 | 960 | 0 | 0 |
| | 8 | 16256 | 15744 | 15232 | 7104 | 3008 | 960 | 0 |
| | 16 | 8064 | 7936 | 7808 | 7552 | 3520 | 1472 | 448 |
| | 32 | 3968 | 3968 | 3904 | 3840 | 3712 | 1728 | 704 |

^{†}In G.997.1 of the recommendation, a 1 ms delay is reserved to mean that S_{P} □ 1 and D_{P}= 1.

TABLE VI.2(+)
Maximum downstream net data rate (kbps) for various values
of delay_min and delay_max and INP_min.

| | | INP_min | | | | | | |
|---|---|---|---|---|---|---|---|---|
| | | 0 | ½ | 1 | 2 | 4 | 8 | 16 |
| delay_min | 1.33^{†} | 24416 | 6560 | 2432 | 416 | 0 | 0 | 0 |
| delay_max | 2.67 | 24416 | 14720 | 6560 | 2432 | 416 | 0 | 0 |
| (ms) | 5.33 | 24416 | 23264 | 14720 | 6560 | 2432 | 416 | 0 |

^{†}Set delay_max = ceil(delay) and delay_min = floor(delay).

TABLE VI.3(+)
Maximum upstream net data rate (kbps) for various values
of delay_min = delay_max and INP_min.

| | | INP_min | | | | | | |
|---|---|---|---|---|---|---|---|---|
| | | 0 | ½ | 1 | 2 | 4 | 8 | 16 |
| delay_min | 1^{†} | 3520 | 0 | 0 | 0 | 0 | 0 | 0 |
| delay_max | 2 | 3520 | 3072 | 1472 | 448 | 0 | 0 | 0 |
| (ms) | 4 | 3520 | 3264 | 1728 | 704 | 192 | 0 | 0 |
| | 8 | 1920 | 1856 | 1792 | 832 | 320 | 64 | 0 |
| | 16 | 896 | 896 | 896 | 832 | 384 | 128 | 0 |
| | 32 | 416 | 416 | 416 | 416 | 384 | 160 | 32 |

^{†}In G.997.1 of the recommendation, a 1 ms delay is reserved to mean that Sₚ □ 1 and Dₚ = 1.

TABLE VI.4(+)
Range of MSGmin and minimum data rate granularity
(net_max − net_min), when delay is selected
from Tables VI.1(+) or VI.3(+).

| MSGmin (kbps) | data rate granularity (kbps) |
|---|---|
| 61-64 | not supported |
| 29-60 | 64 |
| 14-28 | 32 |
| 6-13 | 16 |
| 4-5 | 8 |

TABLE VI.4(+)
Range of MSGmin and minimum data rate granularity
(net_max − net_min), when delay is selected
from Tables VI.1(+) or VI.3(+).

| MSGmin (kbps) | data rate granularity (kbps) |
|---|---|
| 45-64 | not supported |
| 21-44 | 48 |
| 9-20 | 24 |
| 4-8 | 12 |

Because many varying and different exemplary embodiments may be made with the scope of the inventive concepts taught herein, and because many modifications may be made in the exemplary embodiments detailed herein in accordance with the descriptive requirements of the law, it is to be understood that the detailed descriptions herein are to be interpreted as illustrative and not in the limiting sense.

1. A method of constructing a valid set of configuration parameters for an Asymmetric Digital Subscriber Line, version 2 (ADSL2) compliant system, the method comprising:
selecting a delay of one of 1, 2, 4, 8, 16, and 32 ms;
wherein selecting delay=1 ms in the ADSL2 compliant system having a selected minimum noise protection (INP_min)=0 Discrete Multi-tone (DMT) symbols produces a maximum downstream net data rate of 14656 kbps,
wherein selecting delay=2 ms in the ADSL2 compliant system having selected one of INP_min=0, 1/₂, 1 and 2 DMT symbols produces maximum downstream net data rates of 14656, 7104, 3008, and 960, respectively,
wherein a delay=4 ms in the ADSL2 compliant system having one of INP_min=0, ½, 1, 2, and 4 DMT symbols provides maximum downstream net data rates of 14656, 13632, 7104, 3008, and 960 kbps, respectively,
wherein a delay=8 ms in the ADSL2 compliant system having one of ¹NP_min=0, ½, 1, 2, 4 and 8 DMT symbols provides maximum downstream net data rates of 14656, 13632, 13632, 7104, 3008, and 960 kbps, respectively,
wherein a delay=16 ms in the ADSL2 compliant system having one of INP_min=0, ½, 1, 2, 4, 8 and 16 DMT symbols provides maximum downstream net data rates of 8064, 7552, 7552, 7552, 3502, 1472, and 448 kbps, respectively, and
wherein a delay=32 ms in the ADSL2 compliant system having one of INP_min=0, 2, 1, 2, 4, 8 and 16 DMT symbols provides maximum downstream net data rates of 3968, 3712, 3712, 3712, 3712, 1728, and 704 kbps, respectively; and
selecting a minimum net data rate for downstream to be less than a particular maximum downstream net data rate that corresponds to a selected delay and a selected one of INP-min values.

2. A method of constructing a valid set of configuration parameters for an Asymmetric Digital Subscriber Line, version 2 (ADSL2) compliant system, the method comprising:
selecting a delay of one of 1, 2, 4, 8, 16, and 32 ms;
wherein selecting delay=1 ms in the ADSL2 compliant system having a selected minimum noise protection (INP_min)=0 Discrete Multi-tone (DMT) symbols produces a maximum upstream net data rate of 3520 kbps,
wherein selecting delay=2 ms in the ADSL2 compliant system having selected one of INP_min=0, ½, 1 and 2 DMT symbols produces maximum upstream net data rates of 3520, 3072, 1472, and 448, respectively,
wherein a delay=4 ms in the ADSL2 compliant system having one of INP_min=0, ½, 1, 2, and 4 DMT symbols provides maximum upstream net data rates of 3520, 3264, 1728, 704, and 192 kbps, respectively,
wherein a delay=8 ms in the ADSL2 compliant system having one of INP_min=0, ½, 1, 2, 4 and 8 DMT symbols provides maximum upstream net data rates of 1920, 1856, 1792, 832, 320, and 64 kbps, respectively,
wherein a delay=16 ms in the ADSL2 compliant system having one of INP_min=0, ½, 1, 2, 4, 8 and 16 DMT symbols provides maximum upstream net data rates of 896, 896, 896, 832, 384, and 128 kbps, respectively, and
wherein a delay=32 ms in the ADSL2 compliant system having one of INP_min=0, ½, 1, 2, 4, 8 and 16 DMT symbols provides maximum upstream net data rates of 416, 416, 416, 416, 384, 160, and 32 kbps, respectively; and
selecting a minimum net data rate for downstream to be less than a particular maximum upstream net data rate that corresponds to a selected delay and a selected one of INP-min values.

3. A method of constructing a valid set of configuration parameters for an Asymmetric Digital Subscriber Line, version 2+(ADSL2+) compliant system, the method comprising:
selecting a delay of one of 1, 2, 4, 8, 16, and 32 ms;
wherein selecting delay=1 ms in the ADSL2+compliant system having a selected minimum noise protection (INP_min)=0 Discrete Multi-tone (DMT) symbols produces a maximum downstream net data rate of 24416 kbps,
wherein selecting delay=2 ms in the ADSL2+compliant system having selected one of INP_min=0, ½, 1 and 2 DMT symbols produces maximum downstream net data rates of 16256, 7104, 3008, and 960, respectively,
wherein a delay=4 ms in the ADSL2+compliant system having one of INP_min=0, ½, 1, 2, 4, and 8 DMT symbols provides maximum downstream net data rates of 16256, 15232, 7104, 3008, 960, and 416 kbps, respectively,
wherein a delay=8 ms in the ADSL2 compliant system having one of INP_min=0, ½, 1, 2, 4 and 8 DMT symbols provides maximum downstream net data rates of 16256, 15744, 15232, 7104, 3008, and 960 kbps, respectively,
wherein a delay=16 ms in the ADSL2 compliant system having one of INP_min=0, ½, 1, 2, 4, 8 and 16 DMT symbols provides maximum downstream net data rates of 8064, 7936, 7808, 7552, 3520, 1472, and 448 kbps, respectively, and
wherein a delay=32 ms in the ADSL2 compliant system having one of INP_min=0, ½, 1, 2, 4, 8 and 16 DMT symbols provides maximum downstream net data rates of 3968, 3968, 3904, 3840, 3712, 1728, and 704 kbps, respectively; and
selecting a minimum net data rate for downstream to be less than a particular maximum downstream net data rate that corresponds to a selected delay and a selected one of INP-min values.

4. A method of constructing a valid set of configuration parameters for an Asymmetric Digital Subscriber Line, version 2+ (ADSL2+) compliant system, the method comprising:
selecting a delay of one of 1.33, 2.67, and 5.33 ms;
wherein selecting delay=1.33 ms in the ADSL2+compliant system having selected minimum noise protection (INP_min)=0, ½, 1, and 2 Discrete Multi-tone (DMT) symbols produces maximum downstream net data rates of 24416, 6560, 2432, and 416 kbps, respectively,
wherein selecting delay=2,67 ms in the ADSL2+compliant system having selected one of INP_min=0, ½, 1, 2 and 4 DMT symbols produces maximum downstream net data rates of 24416, 1470, 6560, 2432, and 416, respectively,
wherein a delay=5.33 ms in the ADSL2+compliant system having one of INP_min=0, ½, 1, 2, 4, and 8 DMT symbols provides maximum downstream net data rates of 24416, 23264, 14720, 6560, 2432, and 416 kbps, respectively; and
selecting a minimum net data rate for downstream to be less than a particular maximum downstream net data rate that corresponds to a selected delay and a selected one of INP-min values.

5. A method of constructing a valid set of configuration parameters for an Asymmetric Digital Subscriber Line, version 2+(ADSL2+) compliant system, the method comprising:
selecting a delay of one of 1, 2, 4, 8, 16, and 32 ms;
wherein selecting delay=1 ms in the ADSL2+compliant system having a selected minimum noise protection (INP_min)=0 Discrete Multi-tone (DMT) symbols produces a maximum upstream net data rate of 3520 kbps,
wherein selecting delay=2 ms in the ADSL2+compliant system having selected one of INP_min=0, ½, 1 and 2 DMT symbols produces maximum upstream net data rates of 3520, 3072, 1472, and 448, respectively,
wherein a delay=4 ms in the ADSL2+compliant system having one of INP_min=0, ½, 1, 2, and 4 DMT symbols provides maximum upstream net data rates of 3520, 3264, 1728, 704, and 192 kbps, respectively,
wherein a delay=8 ms in the ADSL2+compliant system having one of INP_min=0, ½, 1, 2, 4 and 8 DMT symbols provides maximum upstream net data rates of 1920, 1856, 1792, 832, 320, and 64 kbps, respectively,
wherein a delay=16 ms in the ADSL2 compliant system having one of INP_min=0, ½, 1, 2, 4, 8 and 16 DMT symbols provides maximum upstream net data rates of 896, 896, 896, 832, 384, and 128 kbps, respectively, and
wherein a delay=32 ms in the ADSL2 compliant system having one of INP_min=0, ½, 1, 2, 4, 8 and 16 DMT symbols provides maximum upstream net data rates of 416, 416, 416, 416, 384, 160, and 32 kbps, respectively; and
selecting a minimum net data rate for downstream to be less than a particular maximum upstream net data rate that corresponds to a selected delay and a selected one of INP-min values.
